(19) United States
(12) Patent Application Publication
(10) Pub. No.: US 2002/0132655 A1
(43) Pub. Date: Sep. 19, 2002

(54) Electronic kinesiology game device

(76) Inventors: Richard D. Mercer, Pittsburgh, PA (US); Gregory J. Nicosia, Pittsburgh, PA (US)

Correspondence Address: MCKAY & ASSOCIATES, PC., 801 MCNEILLY ROAD, PITTSBURG, PA, 15226, US

(21) Appl. No.: 10/093,048

(22) Filed: Mar. 7, 2002

Related U.S. Application Data
(60) Provisional application No. 60/276,128, filed on Mar. 15, 2001.

(51) Int. Cl. G06F 19/00

(52) U.S. Cl. 463/1

(57) ABSTRACT

A hand-held, electronic game device for quantifying statements made by a user based on the principles of kinesiology is disclosed. A housing stores a microprocessor and a strain gauge and is adapted to receive a pair of inputs relating to muscle force values received from strength input means and applied simultaneously while contrasting statements are expressed. Software of the microcontroller applies a differential for each reading and couples the digital force readouts on an LCD display with a true/false indication to quantify the thought or amusingly disprove another's verbal expression.

### SPECIFIC REFERENCE

This application hereby claims benefit of provisional application serial No. 60/276,128 for electronic kinesiology game device filed Mar. 15, 2001.

### FIELD OF THE INVENTION

The present invention relates generally to strength testing devices. In particular, a self-actuated electronic game device is taught herein for measuring, displaying, and correlating a muscle force with a true/false reading that quantifies a user's intuition.

### DESCRIPTION OF THE RELATED ART

Applied kinesiologists in the psychological, medical, and chiropractic communities have used muscle testing as a diagnostic methodology by which the body reveals long-hidden information about a person's individual strengths, weaknesses, beliefs and needs for healing.

As known in the art, conventional applied kinesiological (AK) methods involve a volunteer extending one arm out ninety degrees to the side who resists while a facilitator presses down against the arm. When the volunteer makes a truthful statement, such as reciting his or her true name, the arm will remain strong. An untruthful or even negative statement, however, will deplete the volunteer's muscle strength and the arm will drop more easily, or with less resistance. See Muscle Test Comparisons of Congruent and Incongruent Self-Referential Statements, (Monti et al. 1999).

U.S. Pat. No. 5,855,539 teaches an apparatus for applying the above method to oneself. Generally, the testing apparatus includes a base and a foot treadle pivotally attached thereto. A line is attached to a far end of the foot treadle and further adapted to receive a person's arm. When a person has his arm extended out parallel to the floor, a downward force exerted by the foot of the person upon the foot treadle transmits, via the line, a downward force upon the person's arm.

U.S. Pat. No. 4,878,384 to Bruhn teaches a device for evaluating and measuring human sensory perception. Devices of this type are based on the observation that the muscles of the human body produce less force when a certain stimulus occurs, e.g. due to the perception of colors, forms, noises, odors, taste, and touch as well as due to thoughts, memories and the like. The device includes a finger button and display means for displaying the muscle force detected by the detecting means.

A drawback in the prior art exists inasmuch as the evaluation of a muscle force may not accurately depict an emotional state or perception if the means indicating the force does not account for a differential between those emotional states that should be considered negative or positive. A certain numerical value difference should exist between what is true or false, and this difference, upon calibration, must be accounted for. Numerical values having only a small difference between one another do not indicate a substantial contrast when applied to an emotional state. Coupling the numerical value to a true/false indicator means and having a differential applied thereto improves the accuracy and simplifies the response to the muscle force. A validated response can then be used to promote confidence in a self-made statement or indicate a hidden truth for amusement purposes.

Furthermore, in devices generally known to comprise a push-button activated by finger pressure, the pressure received by the button and corresponding pressure sensor is never consistent. This is mainly due to the lack of structures that allow finger placement to be centralized on the button each and every use. For readings to be consistent, the force applied must also be consistent. For example, a force reading from a button having a force applied on its edge may not agree with a second reading received when the same button is pushed on its center. Also, devices that have activation buttons on the front or back of the device may cause accidental placement of more than one finger. There is a need then for a structural housing that is configured to guide a user's finger to a consistent location each and every time.

Generally speaking, of the conscious, subconscious, and the unconscious minds, the subconscious is where we almost unknowingly can resolve problems, process reality, and store information. The subconscious is normally ignored due to its intangibility, being masked by the conscious mind taking care of daily activities and reality. There is a need then for a game device that can quantify a subconscious thought and accurately measure, display, and correlate a muscle force to an emotional state revealed by a user's declaration.

### SUMMARY OF THE INVENTION

The present invention is an electronic game device and method that quantifies applied kinesiology by providing numerical values for muscle strength that are coupled to a true/false indicator means indicating the validity of a statement made by a user. The user may be attempting to quantify his or her intuition or amusingly trying to disprove someone else. The true/false indicator means is actuated after a calibration. Upon the evaluation of a differential applied to the calibrated numerical values, the readings produced are used as a representation of whether or not the statement made indicates an underlying truth or falsehood relative to a subconscious thought.

In one embodiment of the present invention, the device can be used as a means of validating a statement made for amusement purposes inasmuch as the user can substantiate each true/false indication with the documentation discussing the theory behind kinesiology.

A thought can be a verbal statement made to oneself, which could have a yes or no response to correlate to the true/false indication means displaying the answer to the intuition. For example, applied kinesiology tells us the human body is exposed to words or thoughts. Similar to revealing the uncomfortable insecurities that arise when confronted with a lie, a person that recites his or her false name and attempts to resist or provide a muscular force will do so with less power than after a correct recitation, or truth. As such, the body can reveal long-hidden information about a person's individual beliefs and understandings, even if only the subconscious is aware of the situation. Thus, the body can reveal the validity of a statement if the statement is directed to an underlying feeling or memory and accompanied by a contrasting statement or the negation thereof. In this instance, strength tests can confirm or disqualify an intuition.

But a difference in strength values will not inherently indicate a falsehood or truth to an intuition if the difference is insignificant. In the present invention, a difference is validated and a display means will confirm the result. Furthermore, the current device is configured in a manner that allows any difference in the strength values to be directly correlated to the emotional contrasts and not an inaccurate reading caused by misdirected finger pressure on an input.

Accordingly, what is provided is a hand-held electronic game device for quantifying an intuition of a user. The device includes a housing having a front face and a back face. Each face is connected by an area defining a perimeter of the housing with outermost edges of each face raised slightly from the area in circular cross-section to define a channel disposed along the perimeter. A display means is mounted on the front face, and a pair of strength input means is mounted on opposing sides of the perimeter within the channel. They are adapted to be depressed simultaneously by a user's fingers, whereby the user's fingers are guided by the channel to depress each strength input means and display a read-out on the display means.

Internally, the device applies a differential of about 15% for each of the values to assist in validating any difference. The output display means displays and couples each value to a true/false reading indicative of any intuition if the differential is achieved. Each value corresponds to a response to an unknown statement, thereby quantifying the intuition. The true/false display means is not activated until the differential is achieved, but the differential can be displayed after every measurement.

Thus, in a hand-held, electronic game device having a strength input means, a method for quantifying an intuition of a user, comprising the steps of storing a first input, wherein the first input is received by the user expressing a first statement and simultaneously depressing the strength input means; storing a second input, wherein the second input is received by the user expressing a second statement and simultaneously depressing the strength input means; evaluating a difference between each input by having a differential applied; and, coupling the differential to a true/false algorithm.

### BRIEF DESCRIPTION OF THE DRAWINGS

FIG. 1 is a perspective view of the electronic game device.

FIG. 2 is a front view of the display means showing an example of the displayed units.

FIG. 3 is a bottom view of the electronic game device showing the opposing strength input means and perimeter channel.

FIG. 4 shows the circuit schematics for the internal hardware components comprised of the microcontroller and LCD display.

FIG. 5 shows the circuit schematics for the internal hardware components comprised of the strain gauge amplifier and programming connector.

FIG. 6 shows the circuit schematics for the internal hardware components comprised of the push buttons and power supply.

FIG. 7 is a flow diagram representing the software algorithm used by the microcontroller and method of operation of the electronic game device.

### DETAILED DESCRIPTION OF THE PREFERRED EMBODIMENT

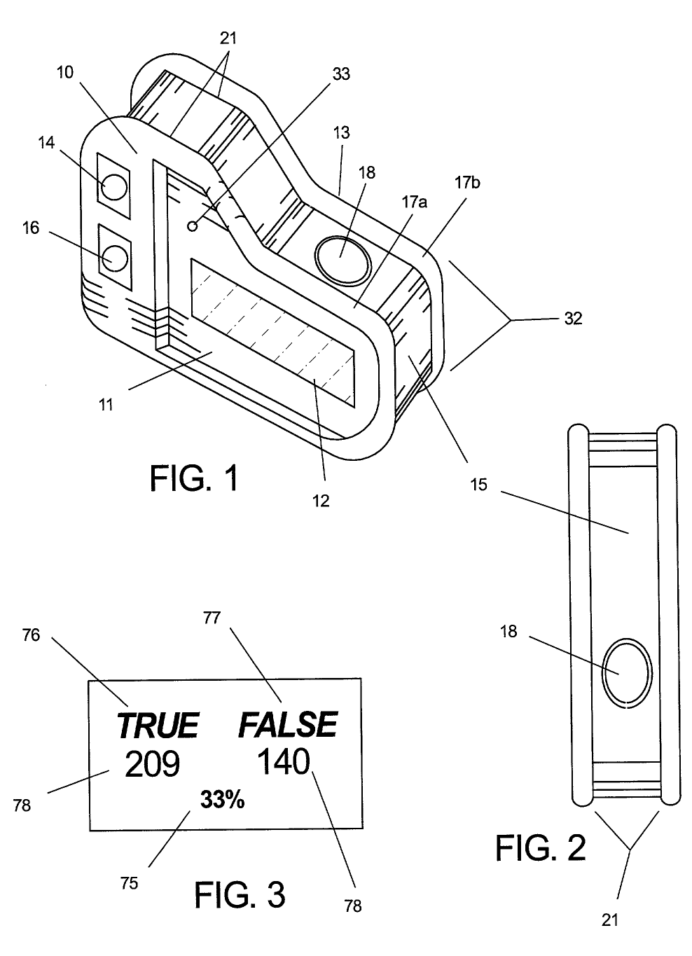

FIGS. 1-3 show the electronic game device of the present invention. The handheld, electronic game device externally includes a housing 10 encasing a display means 12 such as an LCD display, a power button 14, a calibrating button 16, and at least one strength input means 18. The housing 10 is sized to allow the device to be hand-held by a user.

In this embodiment, housing 10 has a front face 11 and a back face 13. Each face is connected by an area defining the perimeter 15 of housing 10. The outermost edges 17a, 17b of each face are raised slightly in circular cross-section to define a channel 21 disposed along the perimeter 15. One side of housing 10, an apex side 32, is configured to conform to the apex of a user's hand. Channel 21 is preferably of a width that accommodates a single finger, whereby only one finger on each side of housing 10 is capable of inputting the strength value and in this manner, a user's finger may rest comfortably within channel for strength value input.

A strength value input is received using a pair of strength input means 18, such as push-buttons capable of depression, which are mounted on opposing sides of the perimeter 15 within channel 21 and proximate to apex side 32.

A power button 14 and a calibration button 16 are mounted on front face 11 encased by housing 10. In this embodiment, which by no means limits the invention to this particular housing design, power button 14 and calibration button 16 are mounted on a side opposite apex side 32.

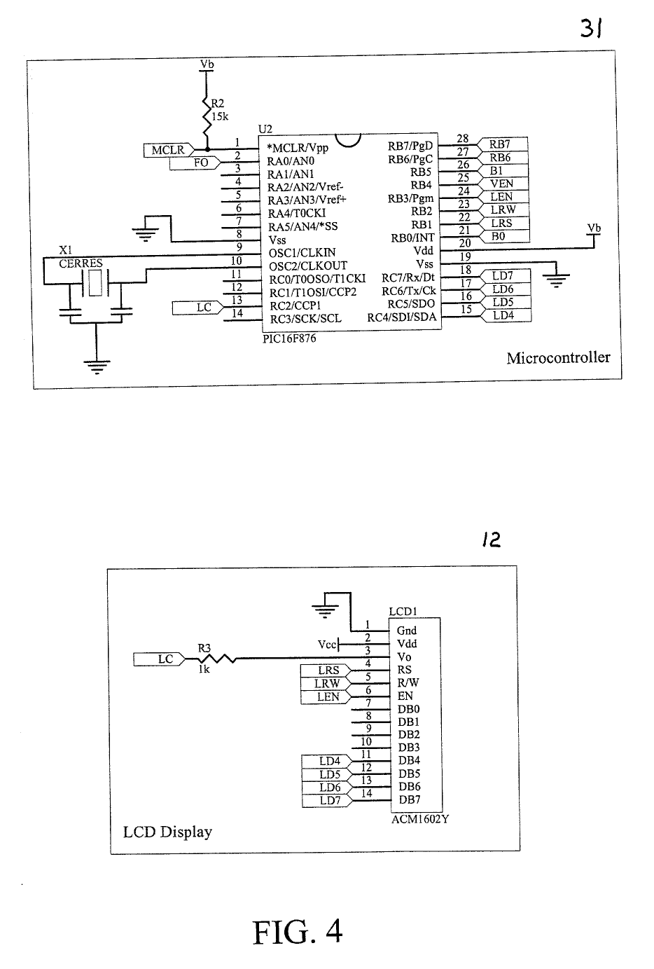

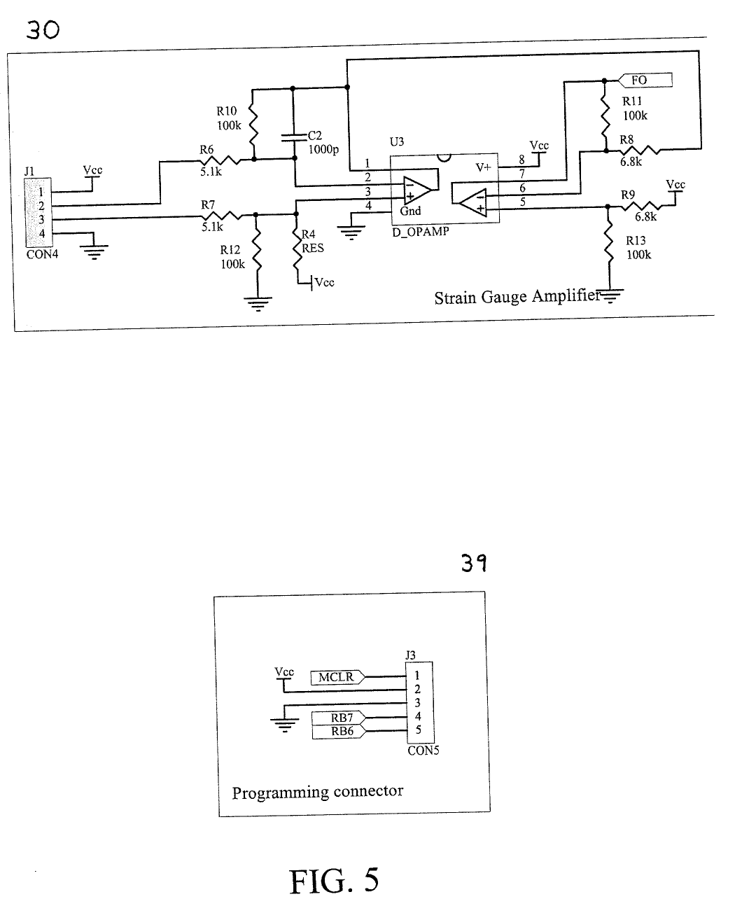

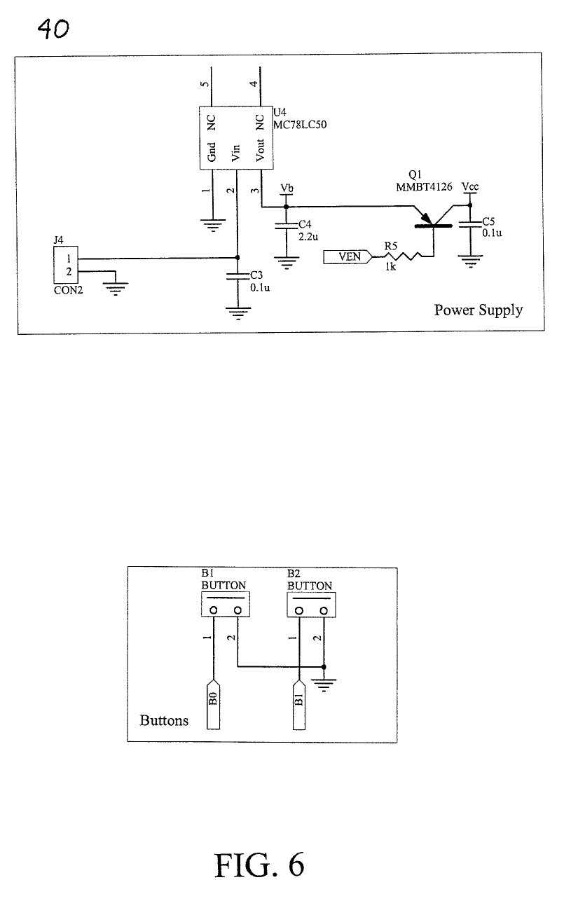

The internal hardware is discussed with reference to FIGS. 4-6 and is mounted within housing 10. An entire circuit is supplied with power from a 9V battery through a power supply 40 voltage regulator. The force sensing of strength input means 18 (FIG. 1 & 2) is done with a full-bridge strain gauge, which is plugged into a 4-pin connector J1. A strain gauge amplifier 30 is used to amplify small voltages, which are proportional to the force generated by strain gauge after the force is applied to strength input means 18. After amplification, strain gauge output is fed into the A/D (analog-to-digital converter) of a microcontroller 31. The microcontroller 31 changes the voltage into a digital value of the force. After scaling, the force value is displayed on the LCD display 12 and used in the software algorithm.

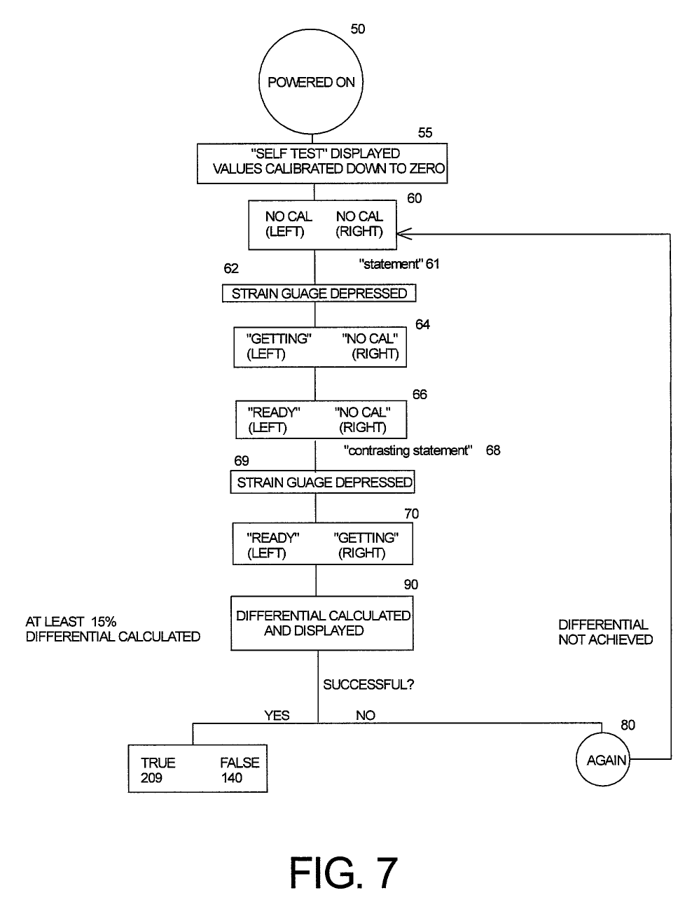

Software resides in the microcontroller 31, which is programmed and adapted to be changed using program connector 39. The software is originally programmed to implement a true/false decision algorithm. The algorithm used in software of microcontroller 31 is discussed below and with reference to FIG. 7, which further demonstrates how the electronic game device is used and operates.

The software is essentially an execution of the algorithm demonstrated using the flow diagram. The software flow diagrams then represent the logic flow that is implemented in the circuits.

With reference then to FIGS. 1-7, electronic game device is powered on 50 using power button 14 and either automatically or by pressing any type of clear button as is generally known in the art, electronic game device, via display means 12, reads “self test” and all values are calibrated down to zero 55. After calibration, display will read “NO CAL” on both left and right sides of display means 12 to indicate no calculated strength measurements have been inputted, at which time electronic game device is ready to “accept” a statement 61.

User then expresses, either verbally or as an internal thought, a statement 61 to his or herself, or to another, which statement 61 should have a true or false, or yes or no answer, such as “I received an A on my last exam.” User simultaneously depresses 62 each strength input means 18 to initiate the receipt of the first value 64, whereby a first input is “ready” and stored 66 while electronic game device awaits the second input.

User can then verbally express a second statement wherein this second statement is a contrasting statement 68 relative to the first statement, such as “I failed that exam.” In this instance, second input will be received and stored when each strength input means 18 is depressed 69 again simultaneously therefor.

Internally as determined by the microprocessor 31, the difference in numerical force values between the first input and the second input is evaluated by having a differential of at least 15% applied 90. This applied differential 90 is coupled to a true/false algorithm as follows:

If result1/result2>1.15, then result1 is true and result2 is false.

If result2/resultl>1.15, the result2 is true and result1 is false.

If neither of the above conditions is correct, then re-measure.

By having the differential applied 90, the difference between the two inputs can be better substantiated, such that the confidence of the user is better met, and any inconsistencies in the results are suppressed.

If the differential 75 is achieved after having been calculated internally (see FIG. 3), the two contrasting results are displayed by display means 12 with one being true 76, and one being false 77, which true/false outputs are accompanied by the displayed numerical force values 78. Using the above example, if the first statement has a higher numerical force value (true) and is at least 15% larger than that of the second, smaller value (false), it just may be that user did do well on the exam, for example. A light indicator 33 may activate on housing 10 (FIG. 1) if the differential 75 is achieved.

The present invention, as should be understood then, can be used to accompany any type of contrasting statements, to at a minimum, promote confidence in the statements made to oneself, and/or disprove or amuse others by evaluating the validity of their statements.

If the differential 75 is not achieved, the electronic game device may reset itself for another attempt by the user. A display element such as “again” 80 may be shown to the user on display means 12. It can be further envisioned then that regardless of whether or not the differential is achieved, a percentage difference of the two values can also be displayed to allow at least one output production after the statements are made. It should also be understood that any type and any number of display characters can accompany the numerical force values.

I claim:

1. A hand-held, electronic game device, comprising:
a housing having a front face and a back face, each said face connecting by an area defining a perimeter of said housing with outermost edges of each said face raised slightly from said area in circular cross-section to define a channel disposed along said perimeter;
a display means mounted on said front face; and,
a pair of strength input means mounted on opposing sides of said perimeter within said channel adapted to be depressed simultaneously by a user's fingers, whereby said fingers are guided by said channel to depress each said strength input means and display a read-out on said display means.

2. The hand-held, electronic game device of claim 1, wherein one side of said housing defined by said perimeter is configured to conform to an apex of a user's hand.

3. The hand-held, electronic game device of claim 1, further comprising a calibration means mounted on said front face.

4. The hand-held, electronic game device of claim 1, further comprising a power button mounted on said front face.

5. The hand-held, electronic game device of claim 1, further comprising internal hardware mounted within said housing.

6. The hand-held, electronic game device of claim 5, wherein said internal hardware includes components selected from the group consisting of a strain gauge, a strain gauge amplifier, a power supply, a programming connector, and a microcontroller.

7. The hand-held, electronic game device of claim 6, wherein said microcontroller further comprises software programmed to compute a differential and couple said differential to a true/false algorithm.

8. A hand-held, electronic game device, comprising:
a housing having a front face and a back face, and a perimeter defined by an area between edges of said front face and said back face;
a display means mounted on said front face;
a pair of strength input means mounted on opposing sides of said perimeter of said housing adapted to be depressed simultaneously by a user's fingers;
a microcontroller mounted within said housing for producing at least one force value received by said strength input means for display on said display means; and
programmed software residing in said microcontroller, wherein a differential of at least 15% is computed and applied to any two or more said force values and coupled to a true/false algorithm.

9. The hand-held, electronic game device of claim 8, further comprising a calibration means mounted on said front face.

10. In a hand-held, electronic game device having a strength input means, a method for quantifying an intuition of a user, comprising the steps of:
storing a first input, wherein said first input is received by said user expressing a first statement and simultaneously depressing said strength input means;
storing a second input, wherein said second input is received by said user expressing a second statement and simultaneously depressing said strength input means;
evaluating a difference between each said input by having a differential applied; and,
coupling said differential to a true/false algorithm.

11. The method of claim 10, wherein before the step of storing said first input, said handheld, electronic game device is calibrated.

12. The method of claim 10, wherein said second statement is a contrasting statement relative to said first statement.

13. The method of claim 10, wherein for the step of evaluating said difference, said differential is at least 15%.

14. The method of claim 10, further comprising the step of displaying one of said inputs as being true and one of said inputs as being false provided said differential is achieved.

15. The method of claim 10, wherein each said input is a numerical force value.
